(19) United States
(12) Patent Application Publication
(10) Pub. No.: US 2005/0132225 A1
(43) Pub. Date: Jun. 16, 2005

(54) Method and system for cyber-security vulnerability detection and compliance measurement (CDCM)

(76) Inventor: Glenn Gearhart, Huntington Beach, CA (US)

Correspondence Address: Joseph C. Andras;MYERS DAWES ANDRAS & SHERMAN LLP, Suite 1150, 19900 MacArthur Blvd., Irvine, CA, 92612, US

(21) Appl. No.: 10/737,503

(22) Filed: Dec. 16, 2003

(51) Int. Cl. H04L 9/32; H04L 9/00; G06F 11/30; G06F 12/14

(52) U.S. Cl. 713/201

(57) ABSTRACT

Method and System for Cyber-Security Vulnerability Detection and Compliance Measurement (CDCM) provides any entity, organization or individual with access to or possession of sensitive, confidential or secret information, defined as “protected information,” in digital format that is received, processed, stored or distributed by a computer, computer system or digital processing equipment with the capability to detect and respond to cyber security vulnerabilities and to measure compliance with cyber-security requirements as established by the Federal Security Information Management Act (FISMA) for the security of protected information and certain additional related desirable or mandatory cyber-security requirements. In one sample embodiment of the invention, the method utilizes a damage assessment function; a security assessment function; a security plan or planning function; a training management function; a response management function; a cyber-security management function; a scoring measurement function; and a review and analysis function; to establish a quantifiable and definitive numerical measurement of the relative compliance of a specific processing system, at a specific point in time, to a defined and established threshold value of performance, or compliance acceptance, and to provide, assemble and be capable of archiving the supporting parameters, status, states and analysis that is specifically associated with the numerical value which represents the specific processing system's state of compliance at the specified time and to utilize various intermediate values and parameters to manage and enhance the performance of the specific system thereby improving the systems compliance score and numerical performance measurement value.

### FIELD OF THE INVENTION

The present invention relates generally to any entity, organization or individual with access to, or possession of, sensitive, confidential or secret information in digital format, defined as “protected” that is received, processed, stored or distributed by a computer, computer system or digital processing equipment. The particular focus of the present invention is to provide a method, apparatus and system to enable a party, with access to a digital based network, to establish, maintain and operate a Cyber-Security Vulnerability Detection and Compliance Measurement (CDCM) system which integrates and analyzes operational parameters and data from various sources and functions to provide intelligence and definitive measurements of the status, vulnerabilities, operational performance and compliance measurements of a system entity, organizations or individual. The invention also provides the capability to report and to archive the definitive results of the various measurements and definitive results provided by the models, processing activities, and the intermediate and local function and/or sub-function performance parameters.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described and in the drawings hereto: Copyright 2002-2003, ACAP Security, Inc., All Rights Reserved.

### BACKGROUND OF THE INVENTION

In recent years the issue of the security, confidentiality and integrity of data which is received, processed, stored and distributed by an entity, organization or individual, or that is transferred between points has become increasingly important. These concern have greatly increased as a result of an increase in cyber-crime activities and the national awareness of the intentions of international terrorists to use cyberspace as a medium to attack and destroy the American way of life.

This invention focuses on addressing at least two major issues associated with cyber-crime attacks, cyber-terror attacks and the man-made and natural disaster which can be directed at or befall a computer system and an entity, organizations or individual.

The first is the difficulty and inability of an entity, organization or individual to obtain quantitative and qualitative knowledge about the current state of the cyber-security operations and the second, is the difficulty and inability of an entity, organization or individual to obtain a definitive relative performance measure as against other similar entity's, organization's or individual's cyber-security operations or as against an established community standard or national standard such as the Federal Information
Security Management Act (FISMA).

Although the prior art addresses various types and systems for measuring and evaluating computer performance, and in some cases an organization's performance, the prior art does not provide for the type of performance and compliance analysis and measurement capabilities provided by this invention. With the current escalation in the actual and threatened cyber-crime attacks and the “always possible” risk of a cyber-terror attack against the United States infrastructure a rapid, accurate and definitive means of measuring the performance of a cyber-security system and the identification of potential cyber-security vulnerabilities is desperately needed.

An indication of some of the areas of performance measurement and providing knowledge about a system such that management can make informed decisions are discussed in the recent prior art in: U.S. Pat. No. 6,609,120, Honarvar, Aug. 19, 2003, 707/3, tilted: Decision management system which automatically searches for strategy components in a strategy; U.S. Pat. No. 6,286,005, Cannon, Sep. 4, 2001, 707/100, titled: Method and apparatus for analyzing data and advertising optimization; U.S. Pat. No. 6,236,975, Boe, May 22, 2001, 705/7, tilted: System and method for profiling customers for targeted marketing; U.S. Pat. No. 6,542,905, Fogel, Apr. 1, 2003, 707/200, tilted: Automated data integrity auditing system.

### SUMMARY OF THE INVENTION

To address the above weaknesses in the prior art and other limitations of the prior art, the present invention provides for any entity, organization or individual to utilize the CDCM system to detect vulnerabilities and measure his system's performance and operational compliance with established standards.

This invention facilitates this capability by utilizing the values of many parameters and data which represents the operational characteristics and processing environment in which a computer or some form of a digital device or group of computers and the networks and communications and processing equipment are operating where the ultimate function and purpose of the CDCM is to establish a quantifiable and definitive numerical measurement of the relative compliance of a specific processing system, at a specific point in time, to a defined and established threshold value of performance or compliance acceptance and to provide, assemble and be capable of archiving the supporting parameters, status, states and analysis specifically associated with the numerical value which represents the specific processing system's state of compliance at the specified time and to utilize various intermediate values and parameters to manage and enhance the performance of the specific system thereby improving the numerical measurement value.

These and other objectives and advantages of the present invention will become clear to those skilled in the art in view of the description of the following sample mode of carrying out the invention and the industrial applicability of the sample embodiment as described herein and as illustrated in the several drawings.

To the accomplishment of the foregoing and related ends, the invention, then, comprises the features hereinafter fully described and particularly pointed out in the claims. The following description and the included drawings set forth in detail certain illustrative embodiments of the invention. These embodiments are indicative, however, of but a very few of the various ways in which the principles of the invention may be employed. Other objectives, advantages and novel features of the invention will become apparent from the following detailed description of the invention when considered in conjunction with the drawings and claims.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and sub-combinations of the disclosed features and/or combinations and sub-combinations of several further features disclosed below in the detailed description.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1—illustrates a diagram of the operational inputs and outputs of a basic CDCM function in accordance with methods and systems consistent with the present invention. It shows the relationships of one required input component and the three output components of a basic function;

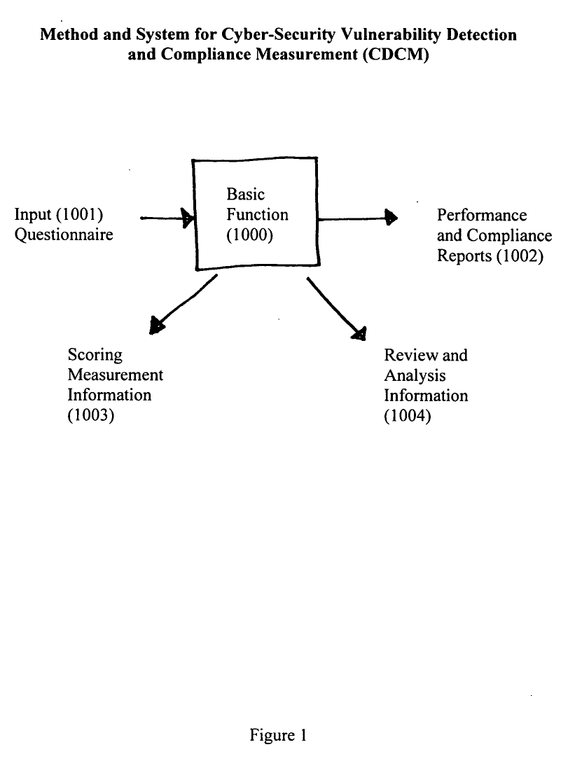

FIG. 2—illustrates a diagram of the functional relationships of a multiple number of basic CDCM functions and the two resulting measurement and review and analysis functions. Identified by name are the six basic CDCM functions utilized in the embodiment of the invention discussed in the detailed description of the invention.

### DETAILED DESCRIPTION OF AN EMBODIMENT OF THE INVENTION

Reference will now be made in detail to the construction and operation of an implementation of the present invention which is illustrated in the accompanying drawings. The present invention is not limited to this presented implementation but it may be realized by many other implementations.

The teachings of the present invention are applicable to many different types of entities, organizations and individuals utilizing different types of computer systems, computer networks and communication systems. As will be appreciated by those of ordinary skill in the art, while the following discussion sets forth various sample or even preferred implementations of the method and system of the present invention, these implementations are not intended to be restrictive of the provided claims, nor are they intended to imply that the claimed invention has limited applicability to one type of computer or communications network.

In this regard, the teachings of the present invention are equally applicable for use in such applications as cyber-security systems, cyber-security defense systems, cyber-security liability defense systems, damage claim defense activities, cyber-security related risk management, risk mitigation systems, insurance coverage pre-condition and continued coverage conditional standards performance measurement systems, litigation and damage claim defense evidence collection systems and many other cyber-security and non-cyber-security applications.

In accordance with the aforementioned needs, the present invention is directed to an CDCM embodiment of the invention which includes: a damage assessment function; a security assessment function; a security plan or planning function; a training management function; a response management function; a cyber-security management function; a scoring measurement function; and a review and analysis function.

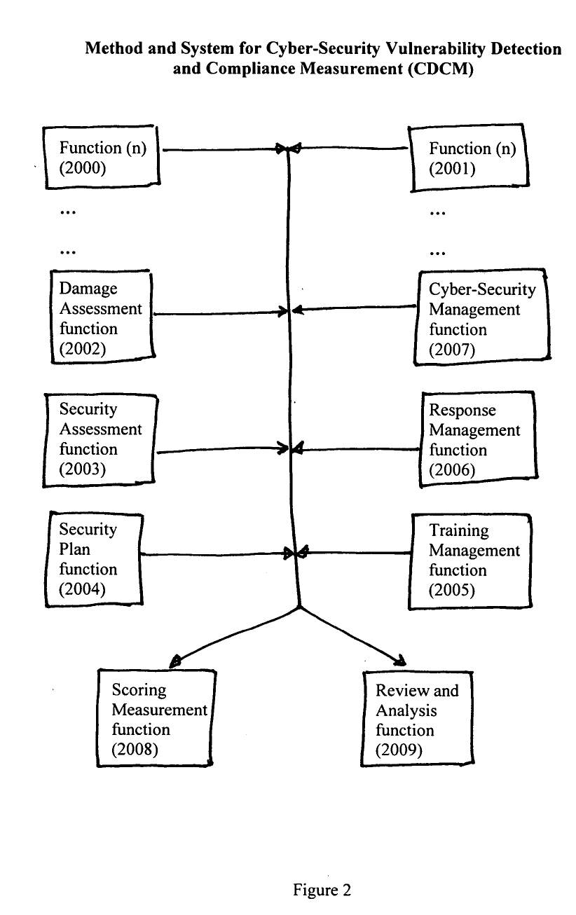

Theses include six basic functions 2002, 2003, 2004, 2005, 2006, and 2007 which are illustrated in FIG. 2. The embodiment also includes two resulting measurement and review and analysis functions 2008 and 2009 which are also illustrated in FIG. 2.

The sample embodiment presented presumes these basic and specialized functions are:

1. Implementing the invention for an entity, organization or individual which is operating one or more computer systems and processing operations and the networks and communications systems and equipment that links the operations and processing capabilities where the ultimate function and purpose of the use of the CDCM is to establish a quantifiable and definitive numerical measurement of the relative compliance of a specific processing system, at a specific point in time, to a defined and established threshold value of performance or compliance acceptance and to provide, assemble and be capable of archiving the supporting parameters, status, states and analysis specifically associated with the numerical value which represents the specific processing system's state of compliance at the specified time and to utilize various intermediate values and parameters to manage and enhance the performance of the specific system thereby improving the numerical measurement value.

2. Wherein the CDCM to perform the damage assessment function, utilizes the values of many parameters and data which represents the operational characteristics and processing environment in which a computer or some form of a digital device or group of computers and the networks and communications and processing equipment:
to perform a financial damage assessment analysis and dollar loss forecasts by determining an estimate and a range of estimates of the total financial impact in dollars, in direct and indirect capital expenditures for the repair and recovery, in direct cash losses, in damage claim losses and other potential expenses, losses and liabilities which could result, or actually resulted from a cyber-crime attack or a cyber-terror attack or some other destructive negative event upon an entity or organization and its computer systems and electronic processing capabilities;
to provide for damage assessment sensitivity analysis and research of the impact of changes in various input parameters and data which are contributors to the resulting damage costs and loss estimates;
to provide in various presentation formats one or more representations of the results of the performance of the damages assessment function and the assemblage of these parameters and data;
to provide in various formats all of the initial, intermediate and final results of the damages assessment function and assemblage of the parameters and the data to a scoring management function, and
to provide in various formats all of the initial, intermediate and final results of the damages assessment function and assemblage of the parameters and the data to a review and analysis function.

3. Wherein the CDCM to perform the security assessment function, utilizes the values of many parameters and data which represents the operational characteristics and processing environment in which a computer or some form of a digital device or group of computers and the networks and communications and processing equipment:
to perform a security assessment analysis of the current status of the states and operational condition of the software, computers, networks, communications and operational equipment; the policies and operating procedures (POPs); the access control; the users security awareness and operational security training; and other measurement parameters which could impact, or which actually do impact the performance of a cyber-security system of a computer system, or an entity or organization and its computer systems and electronic processing capabilities;
to provide for security assessment sensitivity analysis and research of the impact of changes in various input parameters and data which are contributors to the resulting security status and performance estimates;
to provide in various presentation formats one or more representations of the results of the performance of the security assessment function and the assemblage of these parameters and data;
to provide in various formats all of the initial, intermediate and final results of the security assessment function and assemblage of the parameters and the data to a scoring management function, and
to provide in various formats all of the initial, intermediate and final results of the security assessment function and assemblage of the parameters and the data to a review and analysis function.

4. Wherein the CDCM to perform the security plan or planning function, utilizes the values of many parameters and data which represents the operational characteristics and processing environment in which a computer or some form of a digital device or group of computers and the networks and communications and processing equipment:
to perform a security plan development and definition of the current status of the states and operational condition of the software, computers, networks, communications and operational equipment; the policies and operating procedures (POPs); the access control; the users security awareness and operational security training; and other measurement parameters which could impact, or which actually do impact the performance of a cyber-security system of a computer system, or an entity or organization and its computer systems and electronic processing capabilities;
to provide for security planning sensitivity analysis and research of the impact of changes in various input parameters and data which are contributors to the resulting security status and performance estimates;
to provide in various presentation formats one or more representations of the results of the performance of the security planning function and the assemblage of these parameters and data;
to provide in various formats all of the initial, intermediate and final results of the security planning function and assemblage of the parameters and the data to a scoring management function, and
to provide in various formats all of the initial, intermediate and final results of the security planning function and assemblage of the parameters and the data to a review and analysis function.

5. Wherein the CDCM to perform the training management function, utilizes the values of many parameters and data which represents the available educational and training resources, the staffing associated with the operational characteristics and processing environment in which a computer or some form of a digital device or group of computers and the networks and communications and processing equipment; and the needs of those staffing personnel in the area of cyber-security awareness education and operational training:
to perform the functions associated with the mapping of education and training resources to the cyber-security associated staffing of an entity or organization; the scheduling and assignment of staff members to specific education and training courses and the tracking of completion and delinquencies in completion of assigned courses and other management activities;
to provide for security education and training analysis and research of changes in educational and training resources and staffing assignments to courses;
to provide in various presentation formats one or more representations of the results of the performance of the training management function and the assemblage of these parameters and data;
to provide in various formats all of the initial, intermediate and final results of the training management function and assemblage of the parameters and the data to a scoring management function, and
to provide in various formats all of the initial, intermediate and final results of the training management function and assemblage of the parameters and the data to a review and analysis function.

6. Wherein the CDCM to perform the response management function, utilizes the values of many parameters and data which represents the available incidents detections, vulnerability alerts, recovery and repair activities and additional parameters and characteristics associated with the operational characteristics and processing environment in which a computer or some form of a digital device or group of computers and the networks and communications and processing equipment operates within an entity or organization and its computer systems and electronic processing capabilities;
to perform the functions associated with the reporting and tracking of incident detections; incident reports; vulnerability detections and reports; the issuing and management of security alerts; the assignment and management of cyber-security response teams; the tracking and management of evidence archiving; the analysis and mapping of vulnerability trends and focused target points; to collect and manage distribution of incident and vulnerability information both internally and externally; to manage the allocation of response resources to the cyber-security deficiencies and other management activities;
to provide for response management analysis and research of changes in response tactics and strategies, allocation of resources and staffing assignments;
to provide in various presentation formats one or more representations of the results of the performance of the response management function and the assemblage of these parameters and data;
to provide in various formats all of the initial, intermediate and final results of the response management function and assemblage of the parameters and the data to a scoring management function, and
to provide in various formats all of the initial, intermediate and final results of the response management function and assemblage of the parameters and the data to a review and analysis function.

7. Wherein the CDCM to perform the cyber-security management function, utilizes the values of many parameters and data which represents the available entity or organizational security and operational procedures and controls, and cyber-security activities and additional parameters and characteristics associated with the operational characteristics and processing environment in which a computer or some form of a digital device or group of computers and the networks and communications and processing equipment operates within an entity or organization and its computer systems and electronic processing capabilities;
to perform the functions associated with the approving, recording, tracking and reporting of the authorization of staffing members and employees, computer systems and processing equipment and networks for the reception, processing, storing and distribution of sensitive, confidential and secret information; the performance of the similar activities authorization activities for each actual or potential support contactor, supplier and vendor; the management and tracking of the entity's or organization's cyber-security polices and operating procedures (POPs); the management and tracking of the entity's or organization's access controls as related to cyber-security activities and potential vulnerabilities; the management and tracking of the entity's or organization's compliance with the established standard-of-care in the cyber-security of sensitive, confidential and secret information, defined as “protected” information and the associated standard-of-care defense to damage claim liabilities; the management and tracking of the entity's or organization's implementation of the assumption-of-the-risk defense to damage claim liabilities and other cyber-security management activities;
to provide for cyber-security management analysis and research of changes in management tactics and strategies, allocation of resources and staffing assignments;
to provide in various presentation formats one or more representations of the results of the performance of the cyber-security management function and the assemblage of these parameters and data;
to provide in various formats all of the initial, intermediate and final results of the cyber-security management function and assemblage of the parameters and the data to a scoring management function, and
to provide in various formats all of the initial, intermediate and final results of the cyber-security management function and assemblage of the parameters and the data to a review and analysis function.

8. Wherein the CDCM to perform the scoring measurement function, utilizes the values of many parameters and data which represents the available entity or organizational security and operational procedures and controls, and cyber-security activities and additional parameters and characteristics associated with the operational characteristics and processing environment and the management functions form the damage assessment function; the security assessment function; the security plan or planning function; the training management function; the response management function; and the cyber-security management function to establish a quantifiable and definitive numerical measurement of the relative compliance of a specifics processing system, at a specific point in time, to a defined and established threshold value of performance or compliance acceptance and to provide that value in various presentation formats.

9. Wherein the CDCM to perform the review and analysis function, utilizes the values of many parameters and data which represents the available entity or organizational security and operational procedures and controls, and cyber-security activities and additional parameters and characteristics associated with the operational characteristics and processing environment and the management functions form the damage assessment function; the security assessment function; the security plan or planning function; the training management function; the response management function; and the cyber-security management function to provide, assemble and the supporting parameters, status, states and analysis specifically associated with the numerical value which represents the specific processing system's state of compliance at the specified time and to provide in various presentation formats the potential areas of improvement in cyber-security and the detected weaknesses and potential deficiencies in the submitted cyber-security operational state of the analyzed entity's or organization's cyber-security operations.

10. Wherein the CDCM may use an input questionnaire to collect data for the measurements and analysis functions and tasks which in the embodiment of the invention in a security assessment function may include the following:

Standard Security Assessment Questionnaire

Assessment Identification Data

Provide a Standard Security Assessment Identification Number: [us]
Submittal Time: [cs]
Submittal Date: [cs]
   Data on Party Completing Questionnaire:
Name: [us]
ID Number: [us]
Phone number: [us]
e-mail address: [us]
Name of Organization: [us]
Street Address: [us]
City: [us]
State: [us]
Zip: [us]

For the remaining sections of this questionnaire a value must be provided in answer to each question. If for example there are no medical records on your organization's computer system(s) enter the number zero “0” in the entry space. Some value must be entered into every requested entry.

This Security Assessment Questionnaire is an ACAP enhancement and adaptation of the data requested under the Federal government document NIST 800-26.

Name and ID of the General Support System or Major Application System Which is the Subject of this Security Assessment:

System Identification

System Identity: [us]
System Name: [us]
Name of Responsible Party for System: [us]
Name of Cyber-Maintenance Officer (CMO): [us]
   Classification of the System:
[us] General Support System [us] Major Application System
   Assessment Team (Identify at Least One Party)
Name of Assessor: [us]
Name of Organization: [us]
Name of Assessor: [us]
Name of Organization: [us]
Name of Assessor: [us]
Name of Organization: [us]
Assessment Period {S1-F***
Assessment Start Date: (Mo; Day; Yr): [us] [us] [us]
Assessment Completion Date: (Mo; Day; Yr): [us] [us] [us]
   Linked Systems
How many unique linked systems, ones that are sharing the protected information, does this system support? [us]
How many of these linked systems are utilizing an ACAP System for cyber-security of protected information? [us]

[For the following set of questions repeat the set of questions for the number of unique interfaces identified by [ ]

Provide a general description of the Linked System.
Name of a Linked System: [us]
Identity number or identifier of the Linked System: [us]
Type or Classification of the Linked System: (Check Only One).
[us] General Support System [us] Major Application System
Name of a Contact for the Linked System: [us]
Name of the CMO for the Linked System: [us]

Are the boundary controls with this linked system adequate and effective? (Check only one).
[us] Yes [us] No

If the answer was NO; what actions are planned to correct the deficiency?
Comment: [ . . . ]
   Characteristics of System
Confidentiality (Check one).
   [us] High [us] Medium [us] Low
Integrity (Check Only One).
   [us] High [us] Medium [us] Low
Availability (Check Only One).
   [us] High [us] Medium [us] Low
      System Description
How many unique servers are included in this system? [us]
How many of these servers include AWrap capabilities? [us]
How many stationary (non-portable) personnel computers (PCs) either operating as stand-alone computers or as part of a network are included in this system? [us]
How many of these stationary PCs include and therefore provide the use with AWrap capabilities? [us]
How many work stations (WSs) either operating as part of a main-frame system or network are included in this system? [us]
How many of these WSs have access to and therefore provide the use with AWrap capabilities? [us]
How many portable or laptop personnel computers (L-PCs) either operating as stand-alone computers or as part of a network are included in this system? [us]
How many of these portable L-PCs include and therefore provide the user with AWrap capabilities? [us]

Briefly define the Purpose and/or Objective of this current Security Assessment.

Comment: [us . . . ]

Security Assessment Questions

In order to measure the progress of effectively implementing the needed security control, ACAP utilizes four types of system functionality. They are commonly referred to as the POPs status report. These four functionalities translate into five “Levels” in terms current assessment format utilized by many Federal Agencies under the guidelines for computer security assessment established by NIST Special Publication 800-26. A mapping of the ACAP System format to the NIST 800-26 format follows. The ACAP System provides Security Assessment Reports in both formats.

ACAP System Security Assessment Reporting Format: the “POPs Status Report”

(1) [ ] POPs Issued;
(2) [ ] POPs Implemented;
(3) [ ] POPs Needed; and
(4) [ ] POPs Operational
   Mapping of the ACAP System to the NIST 800-26 Format Guidelines:
(1) Are POPs Issued that cover the topics of the question?
   Level 1—control objective documented in a security policy
   Level 2—security controls documented as procedures
(2) Are POPs Implemented that address the topics of the question?
   Level 3—procedures have been implemented
(3) Are more POPs needed to completely address the topics of the question?
   Level 4—procedures and security controls are tested and reviewed
(4) Are POPs Operational and Integrated into the full system covering the topics of the question?
   Level 5—procedures and security controls are fully integrated into a comprehensive program.

The NIST 800-26 format guidelines have established seventeen (17) major topics of control that security should be assessed. The ACAP security assessment questionnaire complies with the NIST 800-26 format guidelines but adds additional questions that focus attention on cyber-crime and cyber-terror issues. Additionally, because compliance with the cyber-security requirements established by the Security Act of 2001 is an important element of every organization's cyber-security system configuration and operational objectives, ACAP has added an eighteenth topic to the security assessment process.

Answer the following list of questions as they apply to the specific major application system or general support system that has been identified as the subject of this security analysis. For [ ] yes; and [ ] no; questions place an “x” in the appropriate answer to the question. For POPs status questions: [ ] POPs Issued; [ ] POPs Implemented; [ ] POPs Needed; and [ ] POPs Operational questions place an “x” in each [ ] that best defines the current state of the POPs. A question may have more than one [ ] with an “x” inserted. If it is helpful in presenting the status, address problems or identify plans provide additional information in the comment or notes sections associated with the question or the topic.

Management Controls

1. Risk Management

Is there a commitment to implement and support this topic?
[ ] Yes [ ] No
Comment: [ . . . ]

Q 1.1 Are cyber-security risks periodically assessed?
[ ] Yes [ ] No
POPs Issued [ ] POPs Implemented [ ] POPs Needed [ ] POPs Operational
Comment: [Leave 3-lines for a comment . . . ]
Security Capabilities Decision: [ ] Reduce [ ] Enhance
Decision Makers Initials: [Leave 5 characteristics for initials]

Q 1.1.1 Is the current system configuration documented, including links to other systems?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.1.2 Are risk assessments performed and documented on a regular basis or whenever the system, facilities, or other conditions change?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.1.3 Has data sensitivity and integrity of the data been considered?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.1.4 Have threat sources, both natural and man-made, been identified?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.1.5 Has a list of known system vulnerabilities, system flaws, or weaknesses that could be exploited by the threat sources been developed and maintained current?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.1.6 Has an analysis been conducted that determines whether the security requirements in place adequately mitigate vulnerabilities?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.1.7 Are damage assessments performed on a regular basis?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.2. Does senior management understand the cyber-crime attack and cyber-terror risks to the organization's computer systems and networks under their control and specifically this computer system and do they determine and set the acceptable level of risk?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.2.1 Are final risk determinations and related management approvals documented and maintained on file?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.2.2 Has a organizational or business operational impact analysis been conducted?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.2.3 Have additional controls and cyber security enhancements been identified to sufficiently mitigate identified risks?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.2.4 Does senior management understand the risks associated with cyber-crime attacks and cyber-terror attacks?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 1.2.5 Does senior management security plans emphasize cyber-security issues?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

2. Review of Security Controls

Is there a commitment to implement and support this topic?
[ ] Yes [ ] No

Comment: [ . . . ]

Q 2.1. Have the cyber-security controls of this system and interconnected systems been reviewed?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 2.11 Has the system and all network boundaries been subjected to periodic reviews?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 2.1.2 Has an independent review been performed annually and when a significant change occurred?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 2.1.3 Are routine security assessments conducted on this computer system?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 2.1.4 Are tests and examinations of key controls routinely made, i.e., network scans, analyses of router and switch settings, penetration testing?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 2.1.5 Are security alerts and security incidents analyzed and remedial actions taken?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 2.16 Are cyber-security incident reports filed and tracked?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 2.2. Does management ensure that corrective actions to cyber vulnerabilities and cyber incidents that affect this system are effectively and timely implemented?
[ ] Yes [ ] No
[ ] POPs Issued [ ] POPs Implemented [ ] POPs Needed [ ] POPs Operational

Comment: [Leave 3 lines for a comment . . . ]
Security Capabilities Decision: [ ] Reduce [ ] Enhance
Decision Makers Initials: [Leave 5 characteristics for initials]

Q 2.2.1 Is there an effective and timely process for reporting significant weakness and ensuring effective remedial action?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

3. Life Cycle

Is there a commitment to implement and support this topic?
[ ] Yes [ ] No
Comment: [ . . . ]

Q 3.1. Has a system development life cycle methodology been developed; are cyber-security risks considered from the initial planning for a new computer system or addition of a computer system through the use and removal of the system?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]
   Initiation Phase

Q 3.1.1 Is the sensitivity of the system determined?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.2 Does the business case document the resources required for adequately securing the system?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.3 Does the Investment process ensure any investment request includes the security resources needed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.4 Are authorizations for software modifications documented and maintained?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.5 Does the budget request include the security resources required for the system?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]
   Development/Acquisition Phase

Q 3.1.6 During the system design, are security requirements identified?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.7 Was an initial risk assessment performed to determine security requirements?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.8 Is there a written agreement with program officials on the security controls employed and residual risk?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.9 Are security controls consistent with and an integral part of the computer system architecture of the organization?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.10 Are the appropriate security controls with associated evaluation and test procedures developed before the procurement action?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.11 Do the solicitation documents for procurements include security requirements and evaluation/test procedures?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.1.12 Do the requirements in the solicitation documents permit updating security controls as new threats and vulnerabilities are identified and as new technologies are implemented?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]
   Implementation Phase

Q 3.2. Are changes controlled as any new software or computer programs are developed or purchased, and installed, tested and finally approved for operational usage?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.1 Are design reviews and system tests run prior to placing the system in production?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.2 Are the test results documented?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.3 Is certification testing of security controls conducted and documented?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.4 If security controls were added since development, has the system documentation been modified to include them?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.5 If security controls were added since development, have the security controls been tested and the system re-certified?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.6 Has the application undergone a technical evaluation to ensure that it meets applicable federal laws, regulations, policies, guidelines, and the standards-of-care requirements?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.7 Does the system have written authorization to operate either on an interim basis with planned corrective action or full authorization?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]
   Operation/Maintenance Phase

Q 3.2.8 Has a system security plan been developed and approved?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.9 If the system connects to other systems, have controls been established and disseminated to the owners of the interconnected systems?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.10 Is the system security plan kept current?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]
   Disposal Phase

Q 3.2.11 Are official electronic records properly disposed and/or archived?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.12 Is information or media securely purged, overwritten, degaussed, or destroyed when disposed or used elsewhere?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 3.2.13 Is a record kept of who implemented the disposal actions and verified that the information or media was sanitized?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

4. Authorize Processing (Certification & Accreditation)

Is there a commitment to implement and support this topic?
[ ] Yes [ ] No
Comment: [ . . . ]

Q 4.1. Is this computer system cyber-security approved or certified/re-certified for operational usage following new software installation, or a software upgrade or modification, and for any and all hardware installations or modifications; (is it an accredited system)?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.1 Has a technical and/or security evaluation been completed or conducted when a significant change occurred?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.2 Has a risk assessment been conducted when a significant change occurred?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.3 Have policies and operating procedures (POPs) been established and signed by users?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.4 Has a contingency plan been developed and tested?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.5 Has a system security plan been developed, updated, and reviewed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.6 Are in-place controls operating as intended?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.7 Are the planned and in-place controls consistent with the identified risks and the system and data sensitivity?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.8 Has management authorized interconnections to all systems (including systems owned and operated by another program, organization, organization or contractor)?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.1.9 Do the planned and in-place controls address the risks of cyber-crime attacks and cyber-terror attacks?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.2. It this computer system or any of its connected networks are required to operate on an interim or temporary approval pending final approval or certification/re-certification, is this system them operated under special operating procedures which address the heightened cyber-crime risks exposure?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 4.2.1 Has management initiated prompt action to correct deficiencies?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

5. System Security Plan

Is there a commitment to implement and support this topic?
[ ] Yes [ ] No
Comment: [ . . . ]

Q 5.1. Has a documented cyber-security plan been prepared for this computer system, and does the plan address security between all networks connected to this system?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 5.1.1 Is the system security plan approved by key affected parties and management?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 5.1.2 Does the plan contain the topics prescribed in the security plan?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 5.1.3 Is a summary of the plan incorporated into the organizations annual budget plan?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 5.2. Is the cyber-security plan for this system kept current?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 5.2.1 Is the plan reviewed periodically and adjusted to reflect current conditions and risks?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

Operational Controls

6. Personnel Security

Is there a commitment to implement and support this topic?
[ ] Yes [ ] No
Comment: [ . . . ]

Q 6.1. Are operational tasks and duties that require access to restricted, sensitive, confidential or secret data (protected data) partitioned or separated to ensure the least possible number of authorized parties have access to the protected data and is there individual accountability of access privileges?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.1 Are all positions reviewed for sensitivity level?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.2 Are there documented job descriptions that accurately reflect assigned duties and responsibilities and that segregate duties?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.3 Are sensitive functions divided among different individuals?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.4 Are distinct systems support functions performed by different individuals?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.5 Are reporting and monitoring mechanisms in place for holding users responsible for their actions?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.6 Are control and security procedures established to support regularly scheduled vacations and periodic job/shift rotations?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.7 Are hiring, transfer, and termination procedures established?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.1.8 Is there a process for requesting, establishing, issuing, and closing user accounts access authority, passwords and encryption keys?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.2. Is appropriate background screening performed on all parties who apply for access privileges to protected data and is approval required prior pot granting privileged access?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.2.1 Are individuals who are authorized to bypass significant technical and operational controls screened prior to access and periodically thereafter?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.2.2 Are confidentiality or security agreements required for employees assigned to work with sensitive information?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.2.3 When controls cannot adequately protect the information, are individuals screened prior to access?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 6.2.4 Are there conditions for allowing system access prior to completion of screening?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

7. Physical and Environmental Protection

Is there a commitment to implement and support this topic?
[ ] Yes [ ] No
Comment: [ . . . ]

Q 7.1. Have adequate physical security controls been implemented that are commensurate with the risks of unauthorized physical access or physical damage to the computer system or the protected data?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.1 Is access to sensitive facilities controlled through the use of guards, identification badges, or entry devices such as key cards or biometrics?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.2 Does management regularly review the list of persons with physical access to sensitive facilities?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.3 Are physical and electronic deposits and withdrawals of storage media from the user library and the backup system authorized and logged?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.4 Are keys or other access devices needed to enter the main and satellite computer rooms, the user library and the backup system facility?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.5 Are unused keys or other entry devices secured?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.6 Do emergency exit and re-entry procedures ensure that only authorized personnel are allowed to re-enter after exiting?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.7 Are visitors to sensitive areas signed in and escorted?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.8 Are entry codes changed periodically?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.9 Are physical accesses monitored through audit trails and apparent or actual security violations investigated and appropriate action taken?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.10 Is suspicious access activity investigated and appropriate action taken?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.11 Are visitors, contractors and maintenance personnel authenticated through the use of preplanned appointments and identification checks?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.12 Are appropriate fire suppression and prevention devices installed and working?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.13 Are fire ignition sources, such as failures of electronic devices or wiring, improper storage materials, and the possibility of arson, criminal entry and terrorist attacks reviewed periodically?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.14 Are heating and air-conditioning systems regularly maintained?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.15 Is there a redundant air-cooling system?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.16 Are electric power distribution, heating plants, water, sewage, and other utilities periodically reviewed for risk of failure?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.17 Are location building plumbing lines known and do not to endanger systems?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.18 Has an uninterruptible power supply or backup generator been provided?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.19 Have controls been implemented to mitigate natural disasters, such as floods, earthquakes, etc.?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.1.20 Have controls been implemented to mitigate man-made disasters, such as a terrorist attack, an unstable employee, a cyber-crime attack?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.2. Is protected data secured from interception and copying during data transfers?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.2.1 Are computer monitors located to eliminate viewing by unauthorized persons?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.2.2 Is physical access to data transmission lines controlled?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.2.3 Is data transmitted in approved encrypted form?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.2.4 Is electronic access to data transmission and distribution media controlled?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.3 Are cyber-security procedures implemented on all of the organization's mobile and portable computer systems which access or process protected data?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.3.1 Are sensitive data files encrypted on all portable systems?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 7.3.2 Are portable systems stored securely?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

8. Production, Input/Output Controls

Is there a commitment to implement and support this topic?
[ ] Yes [ ] No
Comment: [ . . . ]

Q 8.1. Is a user support and help service available for implementation and usage of cyber-security policies, operating procedures and software?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.1.1 Is there a help desk or group that offers advice on security issues?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2. Are there cyber-security control procedures that address the receipt, processing, storage transfer and back-up of protected data in all media formats?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.1 Are there processes to ensure that unauthorized individuals cannot read, copy, alter, or steal printed or electronic information?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.2 Are there processes for ensuring that only authorized users receive, or deliver input and output information and media?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.3 Are audit trails used to monitor sensitive inputs/outputs?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.4 Are controls in place for transporting or mailing media or printed output?

Production, Input/Output Controls

[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.5 Is there internal/external labeling for sensitivity?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.6 Is encryption utilized on sensitive data?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.7 Are audit trails kept for inventory management?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.8 Is media sanitized for reuse?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.9 Is damaged media stored and/or destroyed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 8.2.10 Is hardcopy media shredded or destroyed when no longer needed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

9. Contingency Planning

Is there a commitment to implement and support this topic?
[ ] Yes [ ] No
Comment: [ . . . ]

Q 9.1. Have the most critical and sensitive computer operations and their supporting computer resources been identified?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.1.1 Are critical data files and operations identified and the frequency of file backup documented?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.1.2 Are resources supporting critical operations identified?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.1.3 Have processing priorities been established and approved by management?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2. Has a comprehensive cyber-crime and cyber-terror attack contingency plan been developed and documented?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.1 Is the plan approved by key affected parties?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.2 Are responsibilities for recovery assigned?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.3 Are there detailed instructions for restoring operations?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.4 Is there an alternate processing site; if so, is there a contract or inter-organization agreement in place?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.5 Is the location of stored backups identified?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.6 Are backup files created on a prescribed basis and rotated off-site often enough to avoid disruption if current files are damaged?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.7 Is system and application documentation maintained at the off-site location?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.8 Are all system defaults reset after being restored from a backup?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.9 Are the backup storage site and alternate site geographically removed from the primary site and physically protected?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.2.10 Has the contingency plan been distributed to all appropriate personnel?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.3 Are tested and approved cyber-crime and cyber-terror incident and vulnerability contingency/disaster recovery plans in place?
[ ] Yes [ ] No
[ ] POPs Issued [ ] POPs Implemented [ ] POPs Needed [ ] POPs Operational
Comment: [Leave 3a lines for a comment . . . ]
Security Capabilities Decision: [ ] Reduce [ ] Enhance
Decision Makers Initials: [Leave 5 characteristics for initials]

Q 9.3.1 Is an up-to-date copy of the plan stored securely off-site?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.3.2 Are employees trained in their roles and responsibilities?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 9.3.3 Is the plan periodically tested and readjusted as appropriate?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

10. Hardware and System Software Maintenance

Is there a commitment to implement and support this topic?
[ ] Yes [ ] No
Comment: [ . . . ]

Q 10.1. Are there controls limiting access to computer operating system software, network control software and hardware?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.1.1 Are restrictions in place on who performs maintenance and repair activities?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.1.2 Is access to all program libraries and sensitive data bases restricted and controlled?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.1.3 Are there on-site and off-site maintenance procedures (e.g., escort of maintenance personnel, sanitization of devices removed from the site)?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.1.4 Is the operating system configured to prevent simple circumvention of the security software and application controls?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.1.5 Are up-to-date policies and operating procedures (POPs) in place for using and monitoring use of system utilities?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2. Is all new and modified, or upgraded computer and communications hardware and software, authorized, tested and approved before operational use and implementation?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.1 Is an impact analysis conducted to determine the effect of proposed changes on existing security controls, including the required training needed to implement the control?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.2 Are system components tested, documented, and approved (operating system, utility, applications) prior to promotion to production?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.3 Are software change request forms used to document requests and related approvals?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.4 Are there detailed system specifications prepared and reviewed by management?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.5 Is the type of test data to be used specified, i.e., live or made up?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.6 Are default settings of security features set to the most restrictive mode?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.7 Are there software distribution implementation orders including effective date provided to all locations?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.8 Is there version control?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.9 Are programs labeled and inventoried?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.10 Are the distribution and implementation of new or revised software documented and reviewed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.11 Are emergency change procedures documented and approved by management, either prior to the change or after the fact?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.12 Are contingency plans and other associated documentation updated to reflect system changes?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.13 Is the use of copyrighted software or shareware and personally owned software/equipment documented?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.2.14 Are vulnerability patches documented and reviewed prior to installation?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.3. Is this computer system and connected networks controlled and managed to reduce cyber-crime and cyber-terror vulnerabilities?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.3.1 Are systems periodically reviewed to identify and, when possible, eliminate unnecessary services (e.g., FTP, HTTP, mainframe supervisor calls)?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 10.3.2 Are systems periodically reviewed for known vulnerabilities and software patches promptly installed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

11. Data Integrity

Is there a commitment to implement and support this topic?
[ ] Yes [ ] No
Comment: [ . . . ]

Q 11.1. Is virus detection and elimination software installed and activated on this computer system?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.1.1 Are virus signature files routinely updated?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.1.2 Are virus scans and firewall functions automatic?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.1.3 Is encryption used as a means of obtaining data integrity?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2. Are data integrity and validation controls used to provide assurance that protected data has not been altered and the system operates without deception?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.1 Are reconciliation routines used by applications, i.e., checksums, hash totals, record counts?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.2 Is inappropriate or unusual activity reported, investigated, and appropriate actions taken?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.3 Are procedures in place to determine compliance with password policies and encryption key policies?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.4 Are integrity verification programs used by applications to look for evidence of data tampering, errors, and omissions?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.5 Are intrusion detection tools installed on the system?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.6 Are the intrusion detection reports routinely reviewed and suspected incidents handled accordingly?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.7 Is system performance monitoring used to analyze system performance logs in real time to look for availability problems, including active attacks?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.8 Is penetration testing performed on the system?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 11.2.9 Is message authentication used?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

12. Documentation

Is there a commitment to implement and support this topic?
[ ] Yes [ ] No
Comment: [ . . . ]

Q 12.1. Is there adequate user documentation to support effective utilization of the organization's operational software, computer system, connected networks and computer hardware?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.1 Is there vendor-supplied documentation of purchased software?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.2 Is there vendor-supplied documentation of purchased hardware?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.3 Is there application documentation for in-house developed applications?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials].

Q 12.1.4 Are there network diagrams and documentation on setups of routers and switches?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.5 Are there software and hardware testing procedures and results?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.6 Are there standard operating procedures for all the topic areas covered in this document?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.7 Are there user manuals?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.8 Are there emergency procedures?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.9 Are there backup procedures?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.1.10 Are there recovery procedures?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.2. Are there formal documented cyber-security policies and operational procedures (POPs) addressing use and operation of this computer system and its network connections?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.2.1 Is there a system security plan?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.2.2 Is there a contingency plan?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.2.3 Are there written agreements regarding how data is shared between interconnected systems?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.2.4 Are there risk and damage assessment reports?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 12.2.5 Are there certification and accreditation documents and a statement authorizing the system to process?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

13. Security Awareness, Training, and Education

Is there a commitment to implement and support this topic?
[ ] Yes [ ] No
Comment: [ . . . ]

Q 13.1. Have all employees and contract hires using this computer system received adequate training to fulfill their cyber-security responsibilities?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 13.1.1 Have employees received a copy of the policies and operating procedures, POPs?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 13.1.2 Are employee training and professional development documented and monitored?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 13.1.3 Is there mandatory annual refresher training?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 13.1.4 Are methods employed to make employees aware of security, i.e., posters, booklets, and certified training?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 13.1.5 Have employees received a copy of or have easy access to organization security procedures and policies?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

14. Incident Response Capability

Is there a commitment to implement and support this topic?
[ ] Yes [ ] No
Comment: [ . . . ]

Q 14.1. Is help available and are employees and contract hires trained on how to report and respond to an actual or a potential cyber-security incident or vulnerability that occurs in this, or is perpetrated against this, computer system?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.1.1 Is a formal incident response capability available?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.1.2 Is there a process for reporting incidents?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.1.3 Are incidents monitored and tracked until resolved?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.1.4 Are personnel trained to recognize and handle incidents?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.1.5 Are alerts/advisories received and responded to in a timely manner?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.1.6 Is there a process to modify incident handling procedures and control techniques after an incident occurs?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.2. Is actual or potential cyber-security incident or vulnerability information shared with appropriate law enforcement and cyber-security protection organizations?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.2.1 Is incident information and common vulnerabilities or threats shared with owners of interconnected systems?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.2.2 Is incident information shared with the FBI and law enforcement concerning incidents and common vulnerabilities and threats?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q14.2.3 Is incident information reported to FBI, NIPC, and local law enforcement when necessary?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

Technical Controls

15. Identification and Authentication

Is there a commitment to implement and support this topic?
[ ] Yes [ ] No
Comment: [ . . . ]

Q15.1. Prior to obtaining access, are access rights of approved users of protected information individually authenticated via access keys, passwords, tokens or other access control devices or procedures?
[ ] Yes [ ] No
[ ] POPs Issued [ ] POPs Implemented [ ] POPs Needed [ ] POPs Operational
Comment: [Leave a line for a comment . . . ]
Security Capabilities Decision: [ ] Reduce [ ] Enhance
Decision Makers Initials: [Leave 5 characteristics for initials]

Q 15.1.1 Is a current list maintained and approved of authorized users and their access?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.2 Are digital signatures used and that conform to industry standards?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.3 Are access scripts with embedded passwords prohibited?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.4 Is emergency and temporary access authorized?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.5 Are personnel files matched with user accounts to ensure that terminated or transferred individuals do not retain system access?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.6 Are passwords changed at least every ninety days or earlier if needed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.7 Are passwords unique and difficult to guess (e.g., do passwords require alpha numeric, upper/lower case, and special characters)?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.8 Are inactive user identifications disabled after a specified period of time?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.9 Are passwords not displayed when entered?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.10 Are there procedures in place for handling lost and compromised passwords?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.11 Are passwords distributed securely and users informed not to reveal their passwords to anyone?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.12 Are passwords transmitted and stored using secure protocols/algorithms?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.13 Are vendor-supplied passwords replaced immediately?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.14 Is there a limit to the number of invalid access attempts that may occur for a given user?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.15 Are there procedures in place for handling lost and compromised encryption access keys?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.16 Are encryption access keys distributed securely and users informed not to reveal their passwords to anyone?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.17 Are encryption access keys transmitted and stored using secure protocols/algorithms?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.1.18 Are vendor-supplied encryption access keys replaced immediately?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.2. Do the operational access control procedures ensure enforcement of the segregation of access to protected data?
[ ] Yes [ ] No
[ ] POPs Issued [ ] POPs Implemented [ ] POPs Needed [ ] POPs Operational
Comment: [Leave 3 line for a comment . . . ]
Security Capabilities Decision: [ ] Reduce [ ] Enhance
Decision Makers Initials: [Leave 5 characteristics for initials]

Q 15.2.1 Does the system correlate actions to users?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 15.2.2 Do data owners periodically review access authorizations to determine whether they remain appropriate?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

16. Logical Access Controls

Is there a commitment to implement and support this topic?
[ ] Yes [ ] No
Comment: [ . . . ]

Q 16.1. Do the operational access control procedures ensure the restriction of unauthorized users from access to protected data?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.1 Can the security controls detect unauthorized access attempts?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.2 Is there access control software that prevents an individual from having all necessary authority or information access to allow fraudulent activity without collusion?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.3 Is access to security software restricted to security administrators?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.4 Do workstations disconnect or screen savers lock system after a specific period of inactivity?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.5 Are inactive users' accounts monitored and removed when not needed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.6 Are internal security labels (naming conventions) used to control access to specific information types or files?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.7 If encryption is used, does it meet federal standards?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.8 If encryption is used, are there procedures for key generation, distribution, storage, use, destruction, and archiving?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.9 Is access restricted to files at the logical view or field?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.1.10 Is access monitored to identify apparent security violations and are such events investigated?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2. Are operational access controls required by users of any external networks that are accessible through this computer system?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.1 Has communication software been implemented to restrict access through specific terminals?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.2 Are insecure protocols (e.g., UDP, ftp) disabled?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.3 Have all vendor-supplied default security parameters been reinitialized to more secure settings?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.4 Are there controls that restrict remote access to the system?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.5 Are network activity logs maintained and reviewed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.6 Does the network connection automatically disconnect at the end of a session?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.7 Are trust relationships among hosts and external entities appropriately restricted?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.8 Is dial-in access monitored?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.9 Is access to telecommunications hardware or facilities restricted and monitored?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.10 Are firewalls or secure gateways installed?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.11 If firewalls are installed do they comply with firewall policy and rules?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.12 Are guest and anonymous accounts authorized and monitored?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.13 Is an approved standardized log-on banner displayed on the system warning unauthorized users that they have accessed a restricted system and can be punished?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.14 Are sensitive data transmissions encrypted?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.2.15 Is access to tables defining network options, resources, and operator profiles restricted?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.3. If the public is provided accesses to this computer system, are their controls implemented to protect the integrity of the computer application and the confidence of the public?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 16.3.1 Is a privacy policy posted on all web sites?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

17. Audit Trails

Is there a commitment to implement and support this topic?
[ ] Yes [ ] No
Comment: [ . . . ]

Q 17.1. Are all actual or possible cyber-security incidences or violations of protected data, or any penetrations of this computer system investigated and, to support an investigation, are activity logs maintained on all protected data and the system?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.1 Does the audit trail provide a trace of user actions?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.2 Can the audit trail support after-the-fact investigations of how, when, and why normal operations were interrupted or ceased?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.3 Is access to online audit logs strictly controlled?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.4 Are off-line storage of audit logs retained for a period of time, and if so, is access to audit logs strictly controlled?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.5 Is there separation of duties between security personnel who administer the access control function and those who administer the audit trail?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.6 Are audit trails reviewed frequently?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.7 Are automated tools used to review audit records in real-time or near real-time?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.8 Is suspicious activity investigated and appropriate action taken?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 17.1.9 Is keystroke monitoring used? If so, are users notified?
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Notes: [ . . . ]

18. Targeted Topics

Is there a commitment to support the cyber-security topics?
[ ] Yes [ ] No
Comment: [ . . . ]

Q 18.1. Is there a commitment to support cyber-security System Controls?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.1.1 Does the computer system include software capabilities to control access to protected information and restricted data and are these capabilities being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.1.2 Is the content of the system plan which addresses this system accurate and current?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.1.3 Have agreements with the organization's vendors, suppliers and contactors been revised or amended to address cyber-security of the organization's protected information?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.1.4 Has senior management conveyed to all employees, staff members and contact hires the firm and serious commitment of the organization to cyber-security of protected information?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2. Is there a commitment to support cyber-security Access Controls?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2.1 Are the ASplit procedures being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2.2 Are the ARoute procedures being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2.3 Is AWrap software being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2.4 Is ABox software being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2.5 Is AClean software being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2.6 Are Individual Access Controls being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.2.7 Are Contractual Interface Access Controls being utilized?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.3. Is there a commitment to support cyber-security System Assessments?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.3.1 Have all of the organization's general support systems (GSS) and major application systems (MAS) been identified and has an assessment been performed utilizing the ACAP Security Assessment Program (SAP) on each of the identified systems?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.3.2 Have system assessment compliance and performance reviews of the organization's cyber-security system been scheduled or performed by qualified organizational staff members?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.4. Is there a commitment to support cyber-security Awareness Education?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.4.1 Are Awareness Education Programs available for participation by management, employees and contact hires?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.4.2 Are Awareness Education Programs available for participation by vendors, suppliers, contactors and other parties associated with the organization?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.4.3 Are Awareness Education Programs attendance and education completion records collected and maintained?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.4.4 Are Awareness Education Programs attendance and completion records regularly reviewed and attendance enforced?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.5. Is there a commitment to support cyber-security Operational Training?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.5.1 Are Operational Training Programs available for participation by management, employees and contact hires?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.5.2 Are Operational Training Programs available for participation by vendors, suppliers, contactors and other parties associated with the organization?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.5.3 Are Operational Training Programs attendance and training completion records collected and maintained?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.5.4 Are Operational Training Programs attendance and completion records regularly reviewed and attendance enforced?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.6. Is there a commitment to support cyber-security Incident Reporting and Tracking?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.6.1 Has an Incident Reporting and Tracking system been defined and established which includes participation by qualified organizational staff members and/or contract service providers and includes utilization of the ACAP Response Management Program (RMP)?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.6.2 Has the Incident Reporting and Tracking system been installed and tested?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.7. Is there a commitment to support cyber-security Incident Response and Recovery?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.7.1 Has an Incident Response and Recovery system been defined and established which includes participation by qualified organizational staff members and/or contract service providers and includes utilization of the ACAP Response Management Program (RMP)?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.7.2 Have the Incident Response team(s) members been identified, received assignments, and the Recovery system been tested?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.8. Is there a commitment to support cyber-security Compliance Reviews and Testing?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.8.1 Have compliance and performance reviews of the organization's cyber-security system been scheduled or performed by qualified organizational staff members or contract hires?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.8.2 Have compliance and performance testing of the organization's cyber-security system been scheduled or performed by qualified organizational staff members or contract hires?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.9. Is there a commitment to support cyber-security Independent Reviews and Testing?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.9.1 Have compliance and performance reviews of the organization's cyber-security system been scheduled or performed by a qualified independent review organization?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]

Q 18.9.2 Have compliance and performance testing of the organization's cyber-security system been scheduled or performed by a qualified independent review organization?
[ ] Yes [ ] No
[ ] POPs Issued [ ] POPs Implemented [ ] POPs Needed [ ] POPs Operational
Comment: [Leave 3 lines for a comment . . . ]
Security Capabilities Decision: [ ] Reduce [ ] Enhance
Decision Makers Initials: [Leave 5 characteristics for initials]
   {End of Input Questionnaire}

11. Wherein the CDCM may use an output report to present the results of the measurements and analysis functions and tasks which in the embodiment of the invention in a security assessment function may include the following:

Security Assessment Report

Report as of: [cs] {Date and Time of Report}

Assessment Identification Data

Security Assessment Summary Report Identification Number: [us/cs]
Standard Security Assessment Identification Number: [cs]
Time of Assessment: [cs]
Date of Assessment: [cs]
   Party Completing Questionnaire
Name: [us]
ID Number: [us]
Phone number: [us]
e-mail address: [us]
Name of Organization: [us]
Street Address: [us]
City: [us]
State: [us]
Zip: [us]
   System Identification
   System Identity: [us]
   System Name: [us]
      Party Responsible for System: [us]
   Responsible Cyber-Maintenance Officer (CMO): [us]
      The System is a [cs]
      Classification of the System:
[us] General Support System [us] Major Application System
The assessment team included: [cs]
Assessment Team (Identify at least one party)
Name of Assessor: [us]
   Name of Organization: [us]
Name of Assessor: [us]
   Name of Organization: [us]
Name of Assessor: [us]
   Name of Organization: [us]
Assessment period from [cs] {S1-F-1} to [cs]
   Assessment Period
Assessment Start Date: (Mo; Day; Yr): [us] [us] [us]
Assessment Completion Date: (Mo; Day; Yr): [us] [us] [us]

The System is operating with linked system(s) and of those system(s) are utilizing an ACAP System.

Linked Systems

How many unique linked systems, ones that are sharing the protected information, does this system support? [us]
How many of these linked systems are utilizing an ACAP System for cyber-security of protected information? [us]
   Characteristics of System
Confidentiality State: [cs]
Integrity State: [cs]
Availability State: [cs]
   System Description

The System includes the following processing equipment and AWrap encryption capabilities:

| Processing | Quantity | A Wrap Capabilities |
|---|---|---|
| Servers | [cs] | [cs] |
| Stationary PCs | [cs] | [cs] |
| Workstations | [cs] | [cs] |
| Portable PCs | [cs] | [cs] |

How many unique servers are included in this system? [us]
How many of these servers include AWrap capabilities? [us]
How many stationary (non-portable) personnel computers (PCs) either operating as stand-alone computers or as part of a network are included in this system? [us]
How many of these stationary PCs include and therefore provide the use with AWrap capabilities? [us]
How many work stations (WSs) either operating as part of a main-frame system or network are included in this system? [us]
How many of these WSs have access to and therefore provide the use with AWrap capabilities? [us]
How many portable or laptop personnel computers (L-PCs) either operating as stand-alone computers or as part of a network are included in this system? [us]
How many of these portable L-PCs include and therefore provide the user with AWrap capabilities? [us]

The purpose and/or objective of this Security Assessment was to [cs].

Comment: [us]

Summary of Security Commitments

Security
Commitments

| | Major Security Topics | Yes | No |
|---|---|---|---|
| 1. | Risk Management | [ ] | [ ] |
| 2. | Review of Security Controls | [ ] | [ ] |
| 3. | Life Cycle | [ ] | [ ] |
| 4. | Authorize Processing | [ ] | [ ] |
| 5. | System Security Plan | [ ] | [ ] |
| 6. | Personnel Security | [ ] | [ ] |
| 7. | Physical and Environmental Protection | [ ] | [ ] |
| 8. | Production, Input/Output Controls | [ ] | [ ] |
| 9. | Contingency Planning | [ ] | [ ] |
| 10. | Hardware and Software Maintenance | [ ] | [ ] |
| 11. | Data Integrity | [ ] | [ ] |
| 12. | Documentation | [ ] | [ ] |
| 13. | Security Awareness/Training/Education | [ ] | [ ] |
| 14. | Incident Response Capability | [ ] | [ ] |
| 15. | Identification and Authentication | [ ] | [ ] |
| 16. | Logical Access Controls | [ ] | [ ] |
| 17. | Audit Trails | [ ] | [ ] |
| 18. | Targeted Topics | [ ] | [ ] |
| | Totals | [ ] | [ ] |

### Summary of Security Status

1. Risk Management

Q 1.1 Are cyber-security risks periodically assessed? [cs]

Q 1.2. Does senior management understand the cyber-crime attack and cyber-terror risks to the organization's computer systems and networks under their control and specifically this computer system and do they determine and set the acceptable level of risk? [cs]

2. Review of Security Controls

Q 2.1. Have the cyber-security controls of this system and interconnected systems been reviewed? [cs]

Q 2.2. Does management ensure that corrective actions to cyber vulnerabilities and cyber incidents that affect this system are effectively and timely implemented? [cs]

3. Life Cycle

Q 3.1. Has a system development life cycle methodology been developed; are cyber-security risks considered from the initial planning for a new computer system or addition of a computer system through the use and removal of the system? [cs]

Q 3.2. Are changes controlled as any new software or computer programs are developed or purchased, and installed, tested and finally approved for operational usage? [cs]

4. Authorize Processing

Q 4.1. Is this computer system cyber-security approved or certified/re-certified for operational usage following new software installation, or a software upgrade or modification, and for any and all hardware installations or modifications; (is it an accredited system)? [cs]

Q 4.2. It this computer system or any of its connected networks are required to operate on an interim or temporary approval pending final approval or certification/re-certification, is this system them operated under special operating procedures which address the heightened cyber-crime risks exposure? [cs]

5. System Security Plan

Q 5.1. Has a documented cyber-security plan been prepared for this computer system, and does the plan address security between all networks connected to this system? [cs]

Q 5.2. Is the cyber-security plan for this system kept current? [cs]

6. Personnel Security

Q 6.1. Are operational tasks and duties that require access to restricted, sensitive, confidential or secret data (protected data) partitioned or separated to ensure the least possible number of authorized parties have access to the protected data and is there individual accountability of access privileges? [cs]

Q 6.2. Is appropriate background screening performed on all parties who apply for access privileges to protected data and is approval required prior pot granting privileged access? [cs]

7. Physical and Environmental Protection

Q 7.1. Have adequate physical security controls been implemented that are commensurate with the risks of unauthorized physical access or physical damage to the computer system or the protected data? [cs]

Q 7.2. Is protected data secured from interception and copying during data transfers? [cs]

Q 7.3 Are cyber-security procedures implemented on all of the organization's mobile and portable computer systems which access or process protected data? [cs]

8. Production, Input/Output Controls

Q 8.1. Is a user support and help service available for implementation and usage of cyber-security policies, operating procedures and software? [cs]

Q 8.2. Are there cyber-security control procedures that address the receipt, processing, storage transfer and back-up of protected data in all media formats? [cs]

9. Contingency Planning

Q 9.1. Have the most critical and sensitive computer operations and their supporting computer resources been identified? [cs]

Q 9.2. Has a comprehensive cyber-crime and cyber-terror attack contingency plan been developed and documented? [cs]

Q 9.3 Are tested and approved cyber-crime and cyber-terror incident and vulnerability contingency/disaster recovery plans in place? [cs]

10. Hardware and Software Maintenance

Q 10.1. Are there controls limiting access to computer operating system software, network control software and hardware? [cs]

Q 10.2. Is all new and modified, or upgraded computer and communications hardware and software, authorized, tested and approved before operational use and implementation? [cs]

Q 10.3. Is this computer system and connected networks controlled and managed to reduce cyber-crime and cyber-terror vulnerabilities? [cs]

11. Data Integrity

Q 11.1. Is virus detection and elimination software installed and activated on this computer system? [cs]

Q 11.2. Are data integrity and validation controls used to provide assurance that protected data has not been altered and the system operates without deception? [cs]

12. Documentation

Q 12.1. Is there adequate user documentation to support effective utilization of the organization's operational software, computer system, connected networks and computer hardware? [cs]

Q 12.2. Are there formal documented cyber-security policies and operational procedures (POPs) addressing use and operation of this computer system and its network connections? [cs]

13. Security Awareness/Training/Education

Q 13.1. Have all employees and contract hires using this computer system received adequate training to fulfill their cyber-security responsibilities? [cs]

14. Incident Response Capability

Q 14.1. Is help available and are employees and contract hires trained on how to report and respond to an actual or a potential cyber-security incident or vulnerability that occurs in this, or is perpetrated against this, computer system? [cs]

Q14.2. Is actual or potential cyber-security incident or vulnerability information shared with appropriate law enforcement and cyber-security protection organizations? [cs]

15. Identification and Authentication

Q15.1. Prior to obtaining access, are access rights of approved users of protected information individually authenticated via access keys, passwords, tokens or other access control devices or procedures? [cs]

Q 15.2. Do the operational access control procedures ensure enforcement of the segregation of access to protected data? [cs]

16. Logical Access Controls

Q 16.1. Do the operational access control procedures ensure the restriction of unauthorized users from access to protected data? [cs]

Q 16.2. Are operational access controls required by users of any external networks that are accessible through this computer system? [cs]

Q 16.3. If the public is provided accesses to this computer system, are their controls implemented to protect the integrity of the computer application and the confidence of the public? [cs]

17. Audit Trails

Q 17.1. Are all actual or possible cyber-security incidences or violations of protected data, or any penetrations of this computer system investigated and, to support an investigation, are activity logs maintained on all protected data and the system? [cs]

18. Targeted Topics

Q 18.1. Is there a commitment to support cyber-security System Controls? [cs]

Q 18.2. Is there a commitment to support cyber-security Access Controls? [cs]

Q 18.3. Is there a commitment to support cyber-security System Assessments? [cs]

Q 18.4. Is there a commitment to support cyber-security Awareness Education? [cs]

Q 18.5. Is there a commitment to support cyber-security Operational Training? [cs]

Q 18.6. Is there a commitment to support cyber-security Incident Reporting and Tracking? [cs]

Q 18.7. Is there a commitment to support cyber-security Incident Response and Recovery? [cs]

Q 18.8. Is there a commitment to support cyber-security Compliance Reviews and Testing? [cs]

Q 18.9. Is there a commitment to support cyber-security Independent Reviews and Testing? [cs]

{End of Output Report}

1. A Cyber-Security Vulnerability Detection and Compliance Measurement (CDCM) system comprising:
a set of one through “n” functions or sub-functions each which addresses a operational topic, capability or activity which is either required or desired to be performed in the accomplishment of the mission, task or objective of an organization, entity or individual, where the functions and/or sub-functions by analytical representations either simulates or emulates one or more, or a group of, operational topics, capabilities or activities in the context of a cyber-crime attack, cyber-terror attack or other man-made or natural disaster;
one or more input modules or functions that accept user defined actual or desired operational parameters for each function and/or sub-function;
one or more input modules or functions that accept user defined sensitivity study parameters for various functions and/or sub-functions;
one or more analytical models which translate operational topics, capabilities or activities into dollar definitive representations and transcend the incompatibility of mapping an operational environment into a financial model, a performance model, a compliance model, and related system measurement model configurations which are required to provide measurement results which are representative of, and definitive of, the system and entity, organization or individual which is being measured;
one or more output modules or functions which provide definitive representations of performance and compliance of the system and entity, organization or individual based upon the user defined actual or desired operational parameters for each functions and/or sub-functions as against a defined standard or as a raw non-standardized value;
one or more output modules or functions which provide definitive representations of the vulnerabilities and weaknesses which were observed in the system and entity, organization or individual based upon the user defined actual or desired operational parameters for each functions and/or sub-functions;
one or more output modules or functions which provide the capabilities to report and to archive the definitive and/or parametric results of the various measurements and definitive results provided by these models and processing activities; and
one or more output modules or functions which provide definitive representations of the intermediate and local function and/or sub-function performance parameters and the ability to report and to archive such values and parameters.

2. Wherein the user of the CDCM system defined in claim 1 has the capabilities to use the system in a stand alone, single computer or digital device configuration, or as part of a configuration that includes a network of computers and digital devices.

3. Wherein the user of the CDCM defined in claim 1 has the capabilities to use the device in a direct user present at the computer or digital device configuration, or as part of remote access configuration which may include wireline, wireless or other modes of communications.

4. Wherein the user of the CDCM system defined in claim 1 has the capabilities to use the system in a stand alone, single operations mode, or as part of a configuration that includes a network or grouping of CDCM type of systems.
